(19) United States
(12) Patent Application Publication
(10) Pub. No.: US 2007/0044320 A1
(43) Pub. Date: Mar. 1, 2007

(54) HAIR CLIPPER

(75) Inventors: Makoto FUKUTANI, Osaka (JP); Toshio IKUTA, Osaka (JP); Jiro INABA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 11/466,182

(22) Filed: Aug. 22, 2006

(30) Foreign Application Priority Data
Aug. 26, 2005 (JP) 2005-246797

(51) Int. Cl. B26B 19/00

(52) U.S. Cl. 30/201

(57) ABSTRACT

The hair clipper comprises comb-like fixed blade and movable blade each having a plurality of comb-teeth each provided at its both sides with blades, in which the movable blade is reciprocated with respect to the fixed blade in an arrangement direction of the comb-teeth to cut hair, the fixed blade or the movable blade is slid in a projecting direction of the comb-teeth to adjust cutting height, wherein a tip of each comb-tooth of the fixed blade is provided with a guide projection for introducing hair, the guide projection is tapered with an inclination angle which is larger than an inclination angle of the comb-tooth with respect to projecting direction of blades on both sides of the comb-tooth.

### CROSS REFERENCE TO RELATED APPLICATION

This application is based upon and claims the benefit of priority from prior Japanese Patent-Application P 2005-246797, filed on Aug. 26, 2005; the entire contents of which are incorporated by reference herein.

### BACKGROUND OF THE INVENTION

1. Field of the Invention

The present invention relates to a hair clipper for cutting hair by reciprocating a movable blade with respect to a fixed blade.

2. Description of the Related Art

Conventionally, there is a known hair clipper comprising comb-like fixed blade and movable blade having a plurality of comb-teeth provided at their both sides with blades. This hair clipper is used for cutting hair by reciprocating the movable blade with respect to the fixed blade in an arrangement direction of the comb-teeth. The cutting height can be adjusted by sliding the movable blade with respect to the fixed blade in a projecting direction of the comb-teeth (see Japanese Patent Application Laid-open No. H5-317537).

FIGS. 1A and 1B show a fixed blade 50 of a conventional hair clipper. A plurality of comb-teeth 51 are arranged in parallel on the fixed blade 50. Bach comb-tooth 51 is tapered having small inclination angle α on both side of the comb-tooth 51 in a projecting direction thereof. In order lo enhance efficiency in introducing hair into a blade groove 52 formed between adjacent comb-teeth 51, it is desired that the tip width of the comb-tooth 51 is equal to or smaller than 0.1 millimeter which is a general hair width. For the fixed blade 50 of a hair clipper whose cutting height can be adjusted, however, since it is necessary to largely set the projecting length of the comb-tooth 51 if the tip width of the comb-tooth 51 is reduced as small as about 0.1 millimeter, the entire comb-tooth 51 becomes thin, and there is a problem that the strength thereof cannot be secured.

In this regard, it also seems possible that the tip width of the comb-tooth 51 is set to about 0.1 millimeter, and the inclination angles a on both sides of the teeth are set larger, thereby securing the strength of each comb-tooth 51. However, if the inclination angle a is increased in this manner, since the projecting length L of the comb-tooth 51 is long, the width of the root portion of the comb-tooth 51 becomes extremely wide, and the number of teeth of the entire fixed blade 2 is reduced. As a result, there is a problem that chances for cutting hair are reduced or hairs easily escape from the blade groove 52.

That is, in the case of the hair clipper in which the projecting length L of the comb-tooth 51 of the fixed blade 50 is set long in order to adjust the cutting height, there is a problem that it is difficult to achieve the following three points at the same time, i.e., to enhance the introducing degree of hair between the comb-teeth 51, to secure the strength of the fixed blade 50, and to secure the number of teeth of the fixed blade 50.

### SUMMARY OF THE INVENTION

The present invention has been achieved in view of the above problems, and it is an object of the invention to provide a hair clipper capable of adjusting the cutting height, enhancing the introducing degree of hair, securing the strength of the fixed blade, and securing the number of teeth of the fixed blade at the same time.

To solve the above problem, the present invention provides a hair clipper comprising comb-like fixed blade 2 and movable blade 3 each having a plurality of comb-teeth 2a and 3a each provided at its both sides with blades 2c and 3c, in which the movable blade 3 is reciprocated with respect to the fixed blade 2 in an arrangement direction X of the comb-teeth 2a and 3a to cut hair, the fixed blade 2 or the movable blade 3 is slid in a projecting direction Y of the comb-teeth 2a or 3a to adjust cutting height, wherein a tip of each comb-tooth 2a of the fixed blade 2 is provided with a guide projection 21 for introducing hair, the guide projection 21 is tapered with an inclination angle β which is larger than an inclination angle α of the comb-tooth 2a with respect to projecting direction Y of blades 2c on both sides of the comb-tooth 2a.

According to the hair clipper having the above structure, when hair is to be cut, hair which hits on the guide projection 21 of the fixed blade 2 slips on both tapered surfaces of the inclination angle 1 of the guide projection 21, and the hair is efficiently introduced between the adjacent comb-teeth 2a without falling. Further, the comb-teeth 2a of inclination angle α can keep sufficient width from its root to its tip and thus, the strength can be secured although the projecting length for adjusting the cutting height is long. In addition, since the inclination angle α of the comb-teeth 2a itself is small, the root width of the comb-teeth 2a does not become excessively wide, and the number of teeth is secured.

It is preferable that the tip width of the guide projection 21 is equal to or smaller than a width of hair. As a result, the efficiency in introducing hair is further enhanced.

### BRIEF DESCRIPTION OF THE DRAWINGS

FIGS. 1A and 1B show a fixed blade of a conventional hair clipper, wherein FIG. 1A is a front view and FIG. 1B is an enlarged view of a C portion in FIG. 1A;

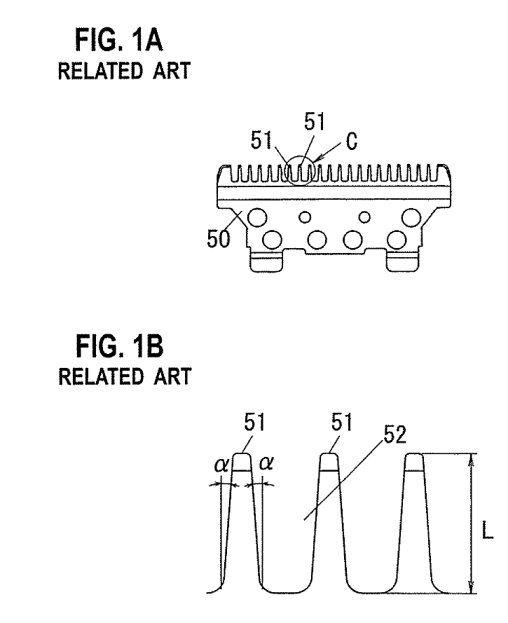

FIGS. 2A and 23 show a fixed blade of a hair clipper which is one example of an embodiment of the present invention, wherein FIG. 2A is a front view and FIG. 23 is an enlarged view of a D portion in FIG. 2A;

FIGS. 3A and 3B show the fixed blade of the hair clipper, wherein FIG. 3A is a sectional view taken along the line I-I in FIG. 2A, and FIG. 33 is an enlarged view or an E portion in FIG. 3A;

FIGS. 4A and 4B show the entire hair clipper, wherein FIG. 4A is a side view and FIG. 4B is a front view;

FIG. 5 is a sectional view taken along the line II-II in FIG. 4B;

FIG. 6 is a perspective view of an entire blade block of the hair clipper;

FIG. 7 is an exploded perspective view of the blade block;

FIGS. 8A and 8B show a case wherein a cutting height of the blade block is set small, wherein FIG. 8A is a front view and FIG. 8B is a side view; and

FIGS. 9A and 9B show a case where the cutting height of the blade block is set large, wherein FIG. 9A is a front view and FIG. 9B is a side view.

### DETAILED DESCRIPTION OF THE PREFERRED EMBODIMENTS

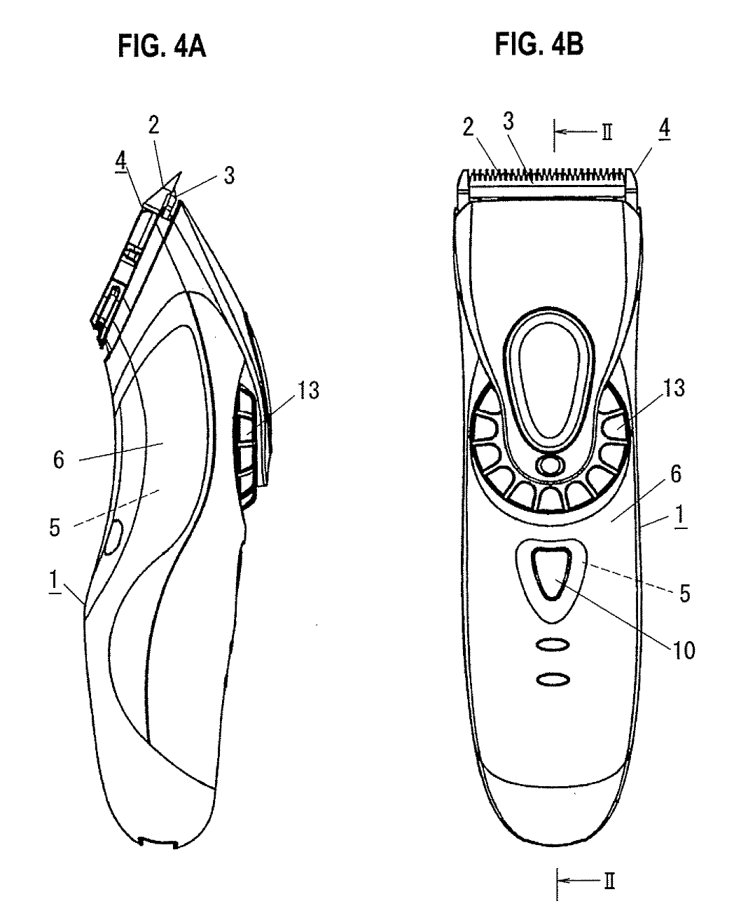

Embodiments of the present invention will be explained below with reference to the drawings. One example of a hair clipper according to an embodiment of the present invention has a thin and long main body 1 which also functions as a grip as shown in FIGS. 4A and 4B. A blade block 4 having a fixed blade 2 and a movable blade 3 is mounted on the top the main body 1 in its longitudinal direction (upper end in FIGS. 4A and 4B) The movable blade 3 of the blade block 4 is reciprocated while sliding in the lateral direction (in FIG. 4B) with respect to the fixed blade 2 by a motor disposed in the main body 1 as a driving source, so that hair introduced into the blade grooves 2b on the tip of the fixed blade 2 is hold between the movable blade 3 and cut.

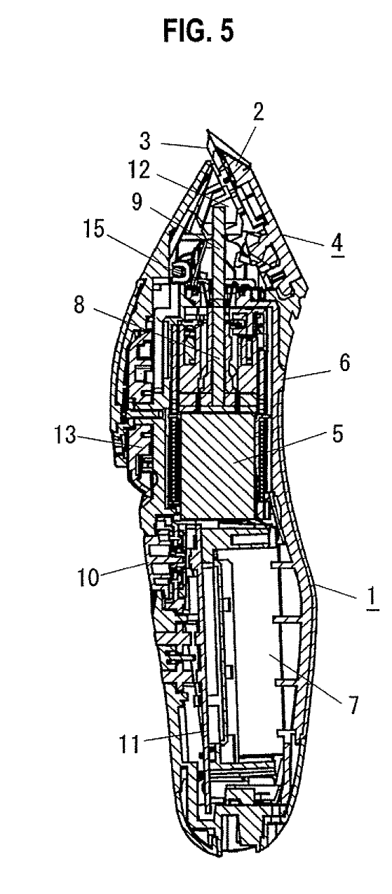

As shown in FIG. 5, the main body 1 has a main body housing 6 forming a substantially S-shaped outer envelope as viewed from side. A user can grasp the main body housing 6 with his or her one hand. Accommodated in the man body housing 6 are a rechargeable battery 7, a motor 5 to which electricity is supplied from the rechargeable battery 7 to be is rotated, a power transmitting mechanism 8 for transmitting a rotation driving force of the motor 5 toward an upper end in the drawing, an eccentric shaft 9 which is rotated by the power transmitting mechanism 8 in an eccentric manner, and a controller 11 which controls electricity supply to the motor 5 in accordance with pushing operation of an operating switch 10 which is exposed outside. The eccentric shaft 9 projects upward in the drawing from the main body housing 6 such that the eccentric shaft 9 is connected to a later-described guide plate 17 provided on the blade block 4. A dial 13 for adjusting the cutting height is turnably disposed on an upper portion (in the drawing) of the operating switch 10 on an outer surface of the main body housing 6. A transmitting mechanism 15 is provided in the main body housing 6. The transmitting mechanism 15 tilts a later-described switch lever 19 of the blade block 4 in association with normal or reverse rotation of the dial 13.

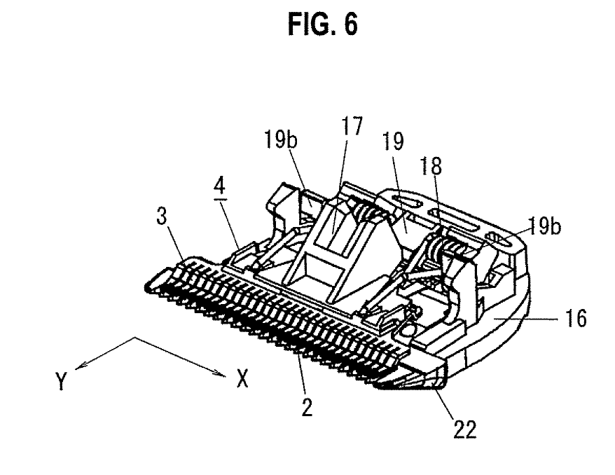

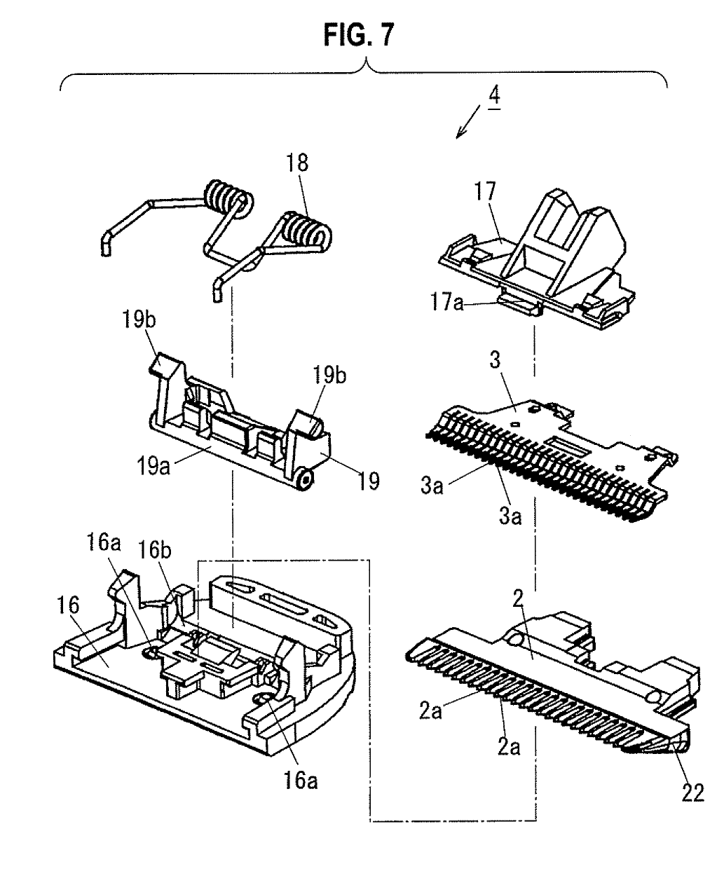

FIG. 6 is a perspective view of the entire blade block 4. FIG. 7 is an exploded perspective view of the blade block 4. The blade block 4 includes the comb-like fixed blade 2 comprising a plurality of tapered comb-teeth 2a each provided at its both sides with blades 2c, the comb-like movable blade 3 having a plurality of tapered comb-teeth 3a each provided at its both sides with blades 3c, a fixing plate 16 which has a hook 16a to be engaged with the fixed blade 2 and which fixes the fixed blade 2 by the hook 16a, a guide plate 17 which has a hook 17a to be engaged with the movable blade 3 and which fixes the movable blade 3 by the hook 17a and a heat seal, a coil-shaped push-up spring 18 disposed between the fixing plate 16 and the guide plate 17 in a resiliently deformed state which gives a biasing force for pushing the movable blade 3 against the fixed blade 2, and a switch lever 19 which has a columnar portion 19a pivotally supported by a semi-circular groove 16b formed in the fixing plate 16, which is disposed on the fixing plate 16 such that the switch lever 19 can tilt around the columnar portion 19a, and which is biased toward its tilting attitude by the push-up spring 18 when the coil portion of the push-up spring 18 is fitted and disposed if the switch lever 19 is turned toward its standing attitude against the biasing force of the push-up spring 18, the movable blade 3 slides toward the projection direction of comb-teeth 2a and 3a while holding a pressing state against the fixed blade 2 (hereinafter, “projecting direction Y”) via the push-up spring 18 and the guide plate 17.

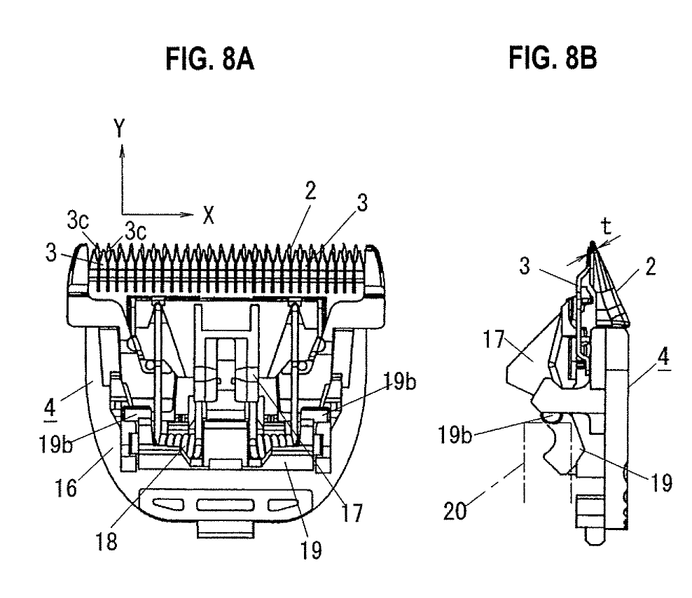

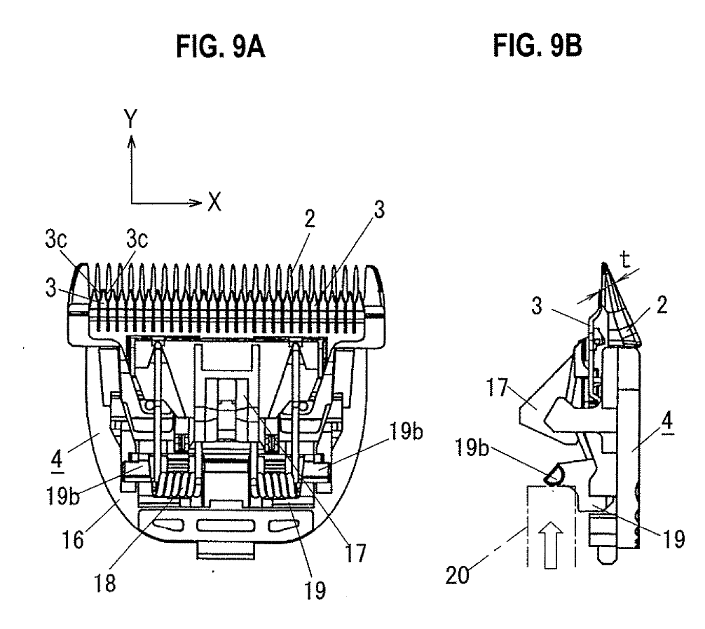

The tilting operation of the switch lever 19 is carried out so that an operation member 20 (see FIGS. 8B, 9B) provided on the transmitting mechanism 15 pushes protections 19b provided on the switch lever 19 in the direction of arrow in FIG. 9B. That is, if the rotation position of the dial 13 is moved in a predetermined positive direction, the switch lever 19 is turned toward its standing attitude through the transmitting mechanism 15 against the biasing force of the push-up spring 18. As a result, the movable blade 3 slides such that tips of the comb-teeth 3a approach the tips of the comb-teeth 2a of the fixed blade 2. If the rotation position of the dial 13 is moved in the opposite direction, the switch lever 19 turns toward its laying attitude by the biasing force of the push-up spring 18, and the movable blade 3 slides such that the tips of the comb-teeth 3a are separated away from the tips of the comb-teeth 2a of the fixed blade 2.

Each comb-tooth 2a of the fixed blade 2 is tapered as viewed from side such that its thickness t is varied along the projecting direction Y. Therefore, by changing the slide position of the movable blade 3 with respect to the fixed blade 2, the cutting height of hair can be adjusted. The above-described cutting height adjusting mechanism is merely one example, and any known cutting height adjusting mechanisms can be used only if the movable blade 3 can be slid in the projecting direction Y with respect to the fixed blade 2 in accordance with a user's operation.

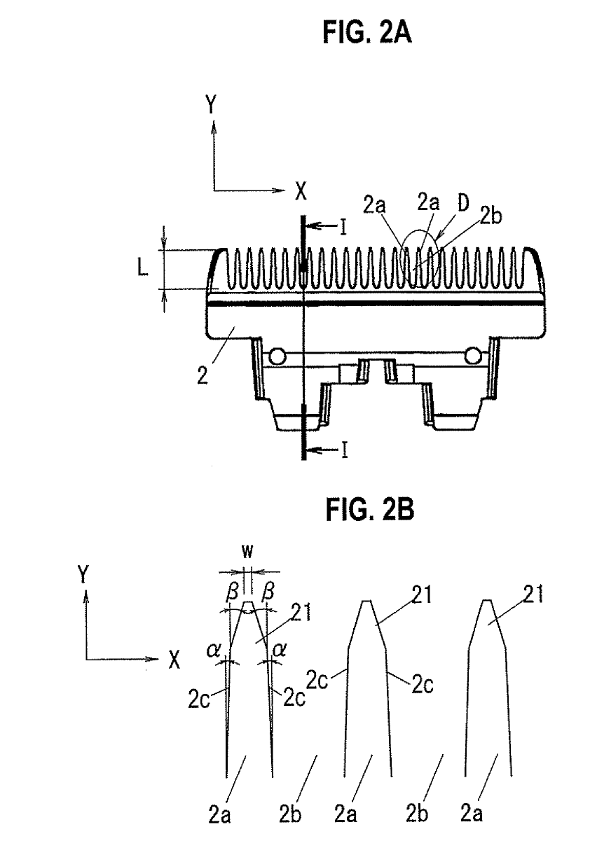

In this example, in order to enhance the efficiency in introducing hair into the blade groove 2b formed between adjacent comb-teeth 2a of the fixed blade 2 while securing strength of the fixed blade 2 of the hairclipper whose cutting height can be adjusted, and in order to secure the number of teeth of the fixed blade 2, each comb-tooth 2a of the fixed blade 2 is provided with a guide projection 21 as shown in FIG. 2B.

Each guide projection 21 is a portion for guiding hair formed on the tip portion of each comb-tooth 2a of the fixed blade 2 projecting toward the tip of the comb-tooth 2a than the comb-teeth 3a of the movable blade 3. The guide projection 21 is tapered with an inclination angle β which is greater than the inclination angle α of the blade 2c on each of both sides of the comb-tooth 2a of the fixed blade 2 with respect to the projecting direction Y. The guide projection 21 has an apical surface which is substantially flat. The inclination angle α is in a range of 0 to 10 so that the widths of the entire comb-teeth 2 are uniform or slightly reduced from their roots toward their tips. The inclination angle β is in a range of 10 to 20 so that the width of the guide projection 21 is abruptly reduced. The guide projection 21 is provided with the apical surface whose width W becomes 0.1 millimeter.

Therefore, when hair is to be cut, hair which hits on the guide projection 21 of the fixed blade 2 slips on both tapered surface of the inclination angle β of the guide projection 21 and is introduced into the blade groove 2b with high efficiency without falling. In order to make it possible to adjust the cutting height, the inclination angle a of the comb-teeth 2a of the fixed blade 2 is small whereas the projecting length is set large. Therefore, the width thereof is about 0.3 millimeter from the root to the tip and strength is secured. In addition, since the inclination angle α is small, the root width of the comb-tooth 2a is not excessively wide, the number of blade grooves 2b is secured, and it is possible to prevent hair from escaping from the blade groove 2b.

Although the apical surface width W of the guide projection 21 is set to 0.1 millimeter that is almost equal to a hair width as described above so as to enhance the efficiency in introducing hair, this width W can be equal to or smaller than 0.1 millimeter.

Smooth convex curved surfaces 22 are formed on both side ends of the fixed blade 2 in a direction in which the comb-teeth 2a are arranged (hereinafter, “arrangement-direction X”) substantially over its entire surface except a surface facing the movable blade 3 (see FIGS. 6 and 7). Each convex curved surface 22 has large radius of curvature. The convex curved surface 22 is convex in shape such that its thickness become smaller toward the end in the arrangement direction X, and the convex curved surface 22 is continuously formed from the root toward the tip of the blade in the projecting direction Y. The slipping degree between the fixed blade 2 and a skin especially when the hair clipper is used while inclining the blade block 4 to cut hair around an ear is excellent.

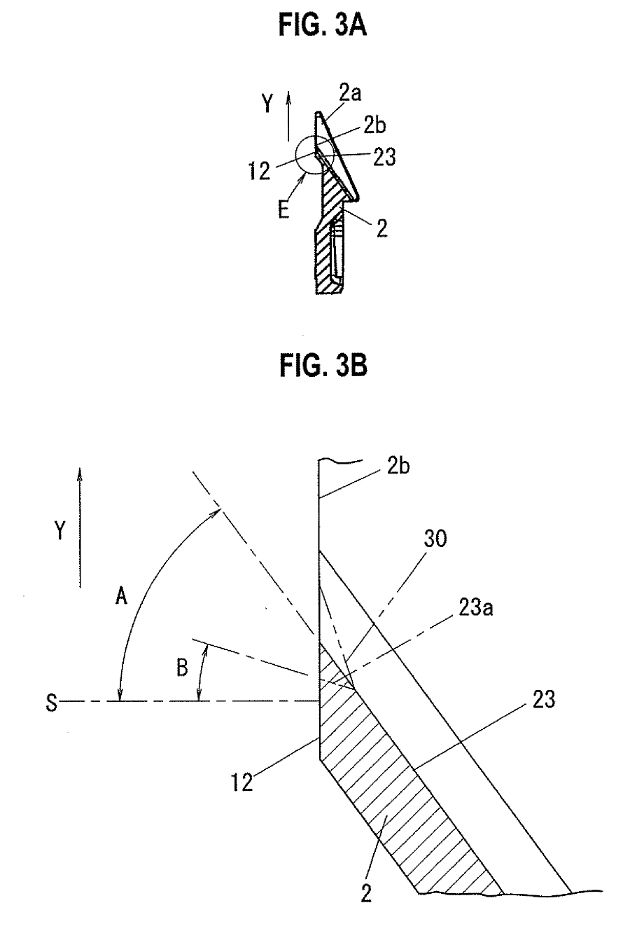

As shown in FIGS. 3A and 3B, the fixed blade 2 is formed with an inclined surface 23 which extends from a bottom edge of the blade groove 2b so that the inclined surface 23 functions as a comb for combing cut hair or not-cut hair. The inclined surface 23 is inclined with respect to a plane S perpendicular to the projecting direction Y by an angle A. When the inclined surface 23 is formed only by the angle A, a burr 30 shown with two-dot chain line in the drawing is adversely generated when it is made possible to polish a sliding surface 12 with respect to the movable blade 3. Thus, an inclined surface 23a shown with one-dotted line inclined by an angle B smaller than the angle A is formed only on a portion of the inclined surface 23 close to the blade groove 2b while taking this burr 30 in consideration. As a result, the amount of burr 30 to be generated is suppressed to the minimum, and it is possible to prevent hair from passing through.

The fixed blade 21 is produced by metal powder injection molding (MIM). Therefore, the shape of each portion of the fixed blade 2 can be formed freely, and since post-machining is unnecessary, cost can be reduced.

According to the present invention, it is possible to adjust the cutting height, enhance the efficiency in introducing hair, secure the strength of the fixed blade, and secure the number of teeth of the fixed blade.

While the embodiment of the present invention has been described above, the invention is not limited to the above embodiment and changes and modifications can be made within the scope of the gist of the present invention.

What is claimed is:

1. A hair clipper comprising comb-like fixed blade and movable blade each having a plurality of comb-teeth each provided at its both sides with blades, in which the movable blade is reciprocated with respect to the fixed blade in an arrangement direction of the comb-teeth to cut hair, the fixed blade or the movable blade is slid in a projecting direction of the comb-teeth to adjust cutting height, wherein a tip of each comb-tooth of the fixed blade is provided with a guide projection for introducing hair, the guide projection is tapered with an inclination angle which is larger than an inclination angle of the comb-tooth with respect to projecting directions of blades on both sides of the comb-tooth.

2. The hair clipper according to claim 1, wherein the tip width of the guide projection is formed to be equal to or smaller than a width of hair.
